(19) United States
(12) Patent Application Publication
(10) Pub. No.: US 2023/0016517 A1
(43) Pub. Date: Jan. 19, 2023

(54) AUXILIARY CONTACT UNIT

(71) Applicant: FUJI ELECTRIC FA COMPONENTS & SYSTEMS CO., LTD., Konosu-shi (JP)

(72) Inventors: Shouta KIKUCHI, Kounosu-city (JP); Kouetsu TAKAYA, Kounosu-city (JP); Koumei HAZAWA, Kounosu-city (JP); Ryotaro NINAGAWA, Kounosu-city (JP)

(73) Assignee: FUJI ELECTRIC FA COMPONENTS & SYSTEMS CO., LTD., Konosu-shi (JP)

(21) Appl. No.: 17/954,075

(22) Filed: Sep. 27, 2022

Related U.S. Application Data
(63) Continuation of application No. PCT/JP2021/010654, filed on Mar. 16, 2021.

(30) Foreign Application Priority Data
Oct. 21, 2020 (JP) 2020-176692

(51) Int. Cl. H01H 50/54; H01H 50/02

(52) U.S. Cl. CPC H01H 50/541; H01H 50/02

(57) ABSTRACT

This auxiliary contact unit includes a case and a case that are divided from each other in the width direction. The case includes a side wall portion and a partition wall portion protruding from a wall surface of the side wall portion toward the case. The case includes a side wall portion having a wall surface with which a tip end of the partition wall portion comes into contact when the case is assembled to the case. A space surrounded by the side wall portion, the partition wall portion, and the side wall portion serves as a contact housing portion. The side wall portion includes a pass-by wall portion protruding from a wall surface toward the side wall portion along the partition wall portion.

### CROSS-REFERENCE TO RELATED APPLICATION

This application is a continuation application filed under 35 U.S.C. § 111 (a) of International Patent Application No. PCT/JP2021/010654, filed on Mar. 16, 2021, the contents of which are incorporated herein by reference.

### TECHNICAL FIELD

The present invention relates to an auxiliary contact unit to be attached to an electromagnetic contactor.

### BACKGROUND ART

An auxiliary contact unit that can be optionally attached to an electromagnetic contactor is a unit that, in an interlocking manner with opening/closing of the electromagnetic contactor, outputs a signal generated by an auxiliary contact to an external electronic control circuit or the like. The types of the auxiliary contact unit include a side-on type contact unit that is attached on a side surface of the body of an electromagnetic contactor, as described in, for example, JP 2012-038644 A.

### SUMMARY OF INVENTION

### Technical Problem

Examples of the structure of the side-on type auxiliary contact unit include a structure in which a case is divided at the center in the width direction and a structure of an integrally molded type in which the case is not divided in the width direction. In the structure in which the case is divided at the center in the width direction, there has been a possibility that dust enters the inside of the auxiliary contact unit through a division surface and the dust causes contact failure of contacts. In the structure of the integrally molded type, while an insertion hole for inserting a fixed contact piece is formed, a height dimension of the insertion hole is set greater than a thickness of the fixed contact piece in order to allow a fixed contact formed on the fixed contact piece to pass through the insertion hole. Hence, a gap is formed between the insertion hole and the fixed contact piece even in the structure of the integrally molded type, and there has been a possibility that dust enters the inside of the auxiliary contact unit through the gap and the dust causes contact failure of contacts.

An object of the present invention is to improve dust-resistant performance of a contact housing portion in an auxiliary contact unit to be attached to an electromagnetic contactor.

### Solution to Problem

According to an aspect of the present invention, there is provided an auxiliary contact unit to be attached on a side surface of an electromagnetic contactor, including a first case and a second case, the first case and the second case being divided from each other in a direction orthogonal to a side surface of the electromagnetic contactor, wherein the first case includes: a first side wall portion parallel with a side surface of the electromagnetic contactor; and a partition wall portions protruding from a wall surface of the first side wall portion toward the second case, the second case includes a second side wall portion parallel with a side surface of the electromagnetic contactor and having a wall surface with which, when the first case and the second case are fitted to each other, a tip end of the partition wall portion comes into contact, a space surrounded by the first side wall portion, the partition wall portion, and the second side wall portion serves as a contact housing portion, and the second side wall portion includes a pass-by wall portion protruding from a wall surface toward the first side wall portion along the partition wall portion.

### Advantageous Effects of Invention

According to the present invention, since the partition wall portion protrudes from the first side wall portion and the pass-by wall portion extending along the partition wall portion protrudes from the second side wall portion, dust is required to pass between the partition wall portion and the pass-by wall portion to enter the contact housing portion. That is, a long entry pathway into the contact housing portion causes dust to be less likely to enter the contact housing portion, as a result of which dust-resistant performance is improved.

### BRIEF DESCRIPTION OF DRAWINGS

FIGS. 1A and 1B are diagrams illustrative of an electromagnetic contactor and an auxiliary contact unit;

FIGS. 2A and 2B are diagrams illustrative of disassembled cases;

FIG. 3 is a diagram illustrative of exploded components;

FIG. 4 is a diagram illustrative of the auxiliary contact unit to which fixed contact pieces are assembled;

FIGS. 5A and 5B are diagrams illustrative of cross sections of the auxiliary contact unit;

FIGS. 6A and 6B are diagrams illustrative of entry pathways for dust;

FIG. 7 is a diagram illustrative of Comparative Example 1; and

FIGS. 8A and 8B are diagrams illustrative of Comparative Example 2.

### DESCRIPTION OF EMBODIMENTS

An embodiment of the present invention will now be described in detail with reference to the drawings. Note that the respective drawings are schematic and do not necessarily depict actual implementation of the present invention. In addition, the embodiment, which will be described below, indicates a device and a method to embody the technical idea of the present invention by way of example, and do not limit the configuration to that described below. That is, the technical idea of the present invention can be subjected to a variety of alterations within the technical scope described in CLAIMS.

### One Embodiment

(Configuration)

In the following description, three directions orthogonal to one another are set to the vertical direction, the width direction, and the depth direction for descriptive purposes.

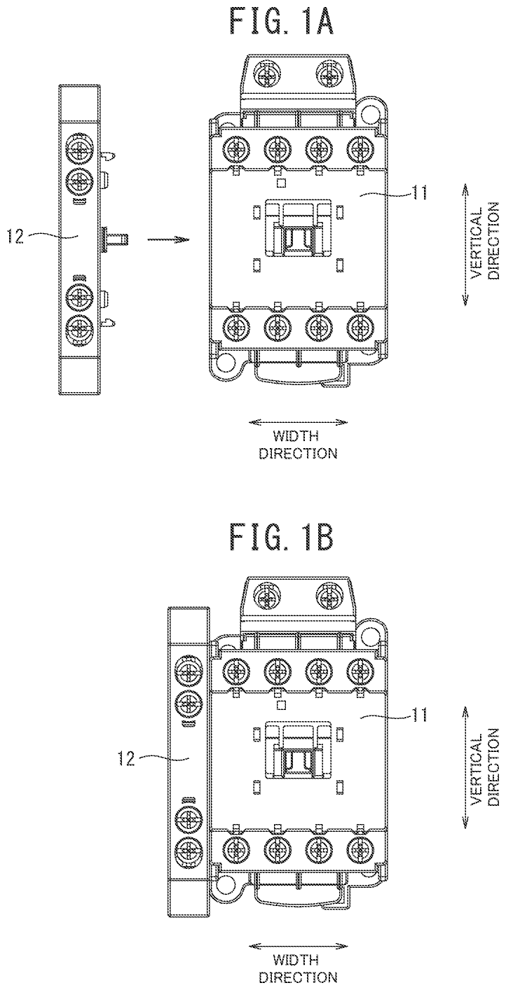

FIGS. 1A and 1B are diagrams illustrative of an electromagnetic contactor and an auxiliary contact unit.

FIGS. 1A and 1B illustrate an electromagnetic contactor 11 and an auxiliary contact unit 12 before the auxiliary contact unit 12 is attached to the electromagnetic contactor 11 and after the auxiliary contact unit 12 has been attached on a side surface of the electromagnetic contactor 11, respectively. Both FIGS. 1A and 1B illustrate external appearances of the electromagnetic contactor 11 and the auxiliary contact unit 12 when viewed from the front side in the depth direction.

The electromagnetic contactor 11 is a device that opens and closes a main circuit, and the auxiliary contact unit 12 is a unit that, in an interlocking manner with opening/closing of the electromagnetic contactor 11, outputs a signal generated by an auxiliary contact to an external electronic control circuit or the like. The auxiliary contact unit 12 is a side-on type contact unit that is attached on a side surface in the width direction of the electromagnetic contactor 11. Although, in this example, the auxiliary contact unit 12 is attached on only one side surface of the electromagnetic contactor 11, the auxiliary contact unit 12 can also be attached on the other side surface in the same manner. The auxiliary contact unit 12 has a structure that allows the auxiliary contact unit 12 to be attached/detached by snap-fits.

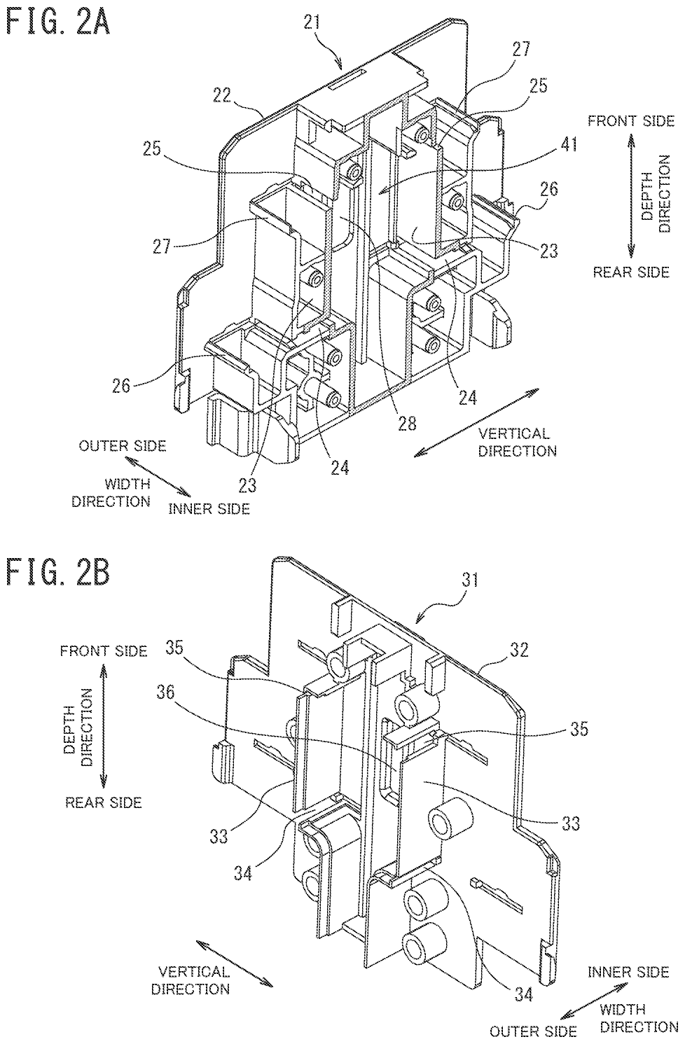

FIGS. 2A and 2B are diagrams illustrative of disassembled cases.

As used herein, the side far from the electromagnetic contactor 11 and the side close to the electromagnetic contactor 11 in the width direction are defined as the outer side and the inner side, respectively. FIGS. 2A and 2B illustrate a case 21 (first case) and a case 31 (second case), respectively. That is, the auxiliary contact unit 12 includes the case 21 and the case 31 that are divided from each other in a direction orthogonal to a side surface of the electromagnetic contactor 11, in other words, in the width direction. Both the case 21 and the case 31 are made of resin, and the inner side in the width direction of the case 21 and the outer side in the width direction of the case 31 are fitted to each other.

The case 21 includes a side wall portion 22 (first side wall portion) and a partition wall portion 23.

The side wall portion 22 is formed in a substantially flat plate shape that is parallel with the side surface of the electromagnetic contactor 11, in other words, that extends along the vertical direction and the depth direction.

The partition wall portion 23 protrudes from a wall surface of the side wall portion 22 toward the case 31, in other words, toward the inner side in the width direction. The partition wall portion 23 surrounds both sides in the vertical direction and both end sides in the depth direction and, in FIG. 2A, the tip end surface of the partition wall portion 23 is illustrated by shading. Note that the area formed along the width direction and the depth direction on both sides in the vertical direction is regarded as main partition wall portions 23 in the following description.

In each of the partition wall portions 23, which are formed on both sides in the vertical direction, a slit-shaped gap 24, which separates the partition wall portion 23 in the depth direction, is formed on the rear side in the depth direction. Each of the partition wall portions 23, which is separated by one of the gaps 24, forms a step composed of wall portions that are displaced from each other in the vertical direction. In addition, in each of the partition wall portions 23, which are formed on both sides in the vertical direction, a slit-shaped gap 25, which separates the partition wall portion 23 in the depth direction, is formed on the front side in the depth direction. Each of the partition wall portions 23, which is separated by one of the gaps 25, forms a step composed of wall portions that are displaced from each other in the vertical direction.

On the side wall portion 22, a pair of receiving wall portions 26 are formed on both outer sides in the vertical direction of the pair of gaps 24. Each of the receiving wall portions 26 receives one end of a fixed contact piece 43, which will be described later, and performs positioning of the fixed contact piece 43 in the vertical direction. On the side wall portion 22, a pair of receiving wall portions 27 are formed on both outer sides in the vertical direction of the pair of gaps 25. Each of the receiving wall portions 27 receives one end of a fixed contact piece 44, which will be described later, and performs positioning of the fixed contact piece 44 in the vertical direction.

At the center in the vertical direction of the side wall portion 22, an opening portion 28, which is long in the depth direction, is formed.

The case 31 includes a side wall portion 32 (second side wall portion) and a pass-by wall portion 33.

The side wall portion 32 is formed in a substantially flat plate shape that is parallel with the side surface of the electromagnetic contactor 11, in other words, that extends along the vertical direction and the depth direction.

The pass-by wall portion 33 protrudes from a wall surface of the side wall portion 32 toward the side wall portion 22 along the partition wall portions 23. Note that the area formed along the width direction and the depth direction on both sides in the vertical direction is regarded as main pass-by wall portions 33 in the following description.

In each of the pass-by wall portions 33, which are formed on both sides in the vertical direction, a slit-shaped gap 34, which separates the pass-by wall portion 33 in the depth direction, is formed on the rear side in the depth direction. In addition, in each of the pass-by wall portions 33, which are formed on both sides in the vertical direction, a slit-shaped gap 35, which separates the pass-by wall portion 33 in the depth direction, is formed on the front side in the depth direction.

At the center in the vertical direction of the side wall portion 32, an opening portion 36, which is long in the depth direction, is formed.

The case 21 and the case 31 are fastened with bosses thereof fitted to each other, and, when both cases are fitted to each other, the tip ends of the partition wall portions 23 come into contact with the wall surface of the side wall portion 32. An interior space surrounded by the side wall portion 22, the partition wall portions 23, and the side wall portion 32 in this way serves as a contact housing portion 41.

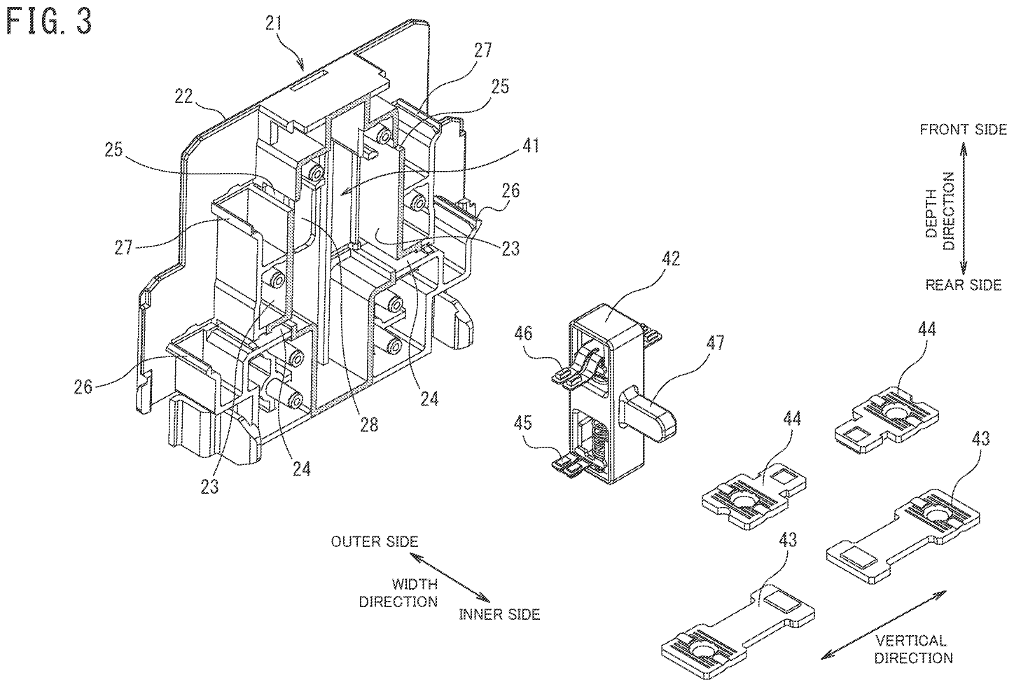

FIG. 3 is a diagram illustrative of exploded components.

The auxiliary contact unit 12 includes a contact support 42, a pair of fixed contact pieces 43, and a pair of fixed contact pieces 44.

The contact support 42 is made of resin and is housed in the contact housing portion 41 while being advanceable and retractable in the depth direction.

In the contact support 42, a movable contact piece 45 is disposed on the rear side in the depth direction, and a movable contact piece 46 is disposed on the front side in the depth direction. The movable contact pieces 45 and 46 are plate-shaped conductors extending in the vertical direction, protrude out of the contact support 42 toward both end sides in the vertical direction, and have both end sides bifurcating and forming dual contacts. The movable contact piece 45 has contacts formed on a surface on the rear side in the depth direction, and the movable contact piece 46 has contacts formed on a surface on the front side in the depth direction.

On a side surface of the contact support 42, a coupling protrusion 47, which protrudes toward the inner side in the width direction, is formed. The coupling protrusion 47 protrudes out of the side wall portion 32 through the opening portion 36 and, although illustration is omitted, is fitted into a coupling recessed portion, which is formed in a contact support of the electromagnetic contactor 11. Because of this configuration, when the contact support of the electromagnetic contactor 11 advances and retracts in the depth direction, the contact support 42 of the auxiliary contact unit 12 advances and retracts in the depth direction in an interlocking manner with the advancement and retraction of the contact support of the electromagnetic contactor 11.

The pair of fixed contact pieces 43 are plate-shaped conductors extending along the width direction and the vertical direction and are respectively fitted into the gaps 24 of the partition wall portions 23 from the case 31 side, and the positions in the vertical direction of the pair of fixed contact pieces 43 are determined by the receiving wall portions 26. Each of the fixed contact pieces 43 has a contact formed on a surface on the front side in the depth direction at an end portion located on the inner side in the vertical direction and a threaded hole for a screw terminal formed on the outer side in the vertical direction. It is herein assumed that an auxiliary contact including the fixed contact pieces 43 and the movable contact 45 is an a-contact of a normally-open type. That is, when main contacts of the electromagnetic contactor 11 are opened, the contact support 42 being positioned on the front side in the depth direction causes the movable contact piece 45 to be separated from the fixed contact pieces 43 and the auxiliary contact to be opened. In contrast, when the main contacts of the electromagnetic contactor 11 are closed, the contact support 42 being positioned on the rear side in the depth direction causes the movable contact piece 45 to come into contact with the fixed contact pieces 43 and the auxiliary contact to be closed.

The pair of fixed contact pieces 44 are plate-shaped conductors extending along the width direction and the vertical direction and are respectively fitted into the gaps 25 of the partition wall portions 23 from the case 31 side, and the positions in the vertical direction of the pair of fixed contact pieces 44 are determined by the receiving wall portions 27. Each of the fixed contact pieces 44 has a contact formed on a surface on the rear side in the depth direction at an end portion located on the inner side in the vertical direction and a threaded hole for a screw terminal formed on the outer side in the vertical direction. It is herein assumed that an auxiliary contact including the fixed contact pieces 44 and the movable contact piece 46 is a b-contact of a normally-closed type. That is, when the main contacts of the electromagnetic contactor 11 are opened, the contact support 42 being positioned on the front side in the depth direction causes the movable contact piece 46 to come into contact with the fixed contact pieces 44 and the auxiliary contact to be closed. In contrast, when the main contacts of the electromagnetic contactor 11 are closed, the contact support 42 being positioned on the rear side in the depth direction causes the movable contact piece 46 to be separated from the fixed contact pieces 44 and the auxiliary contact to be opened.

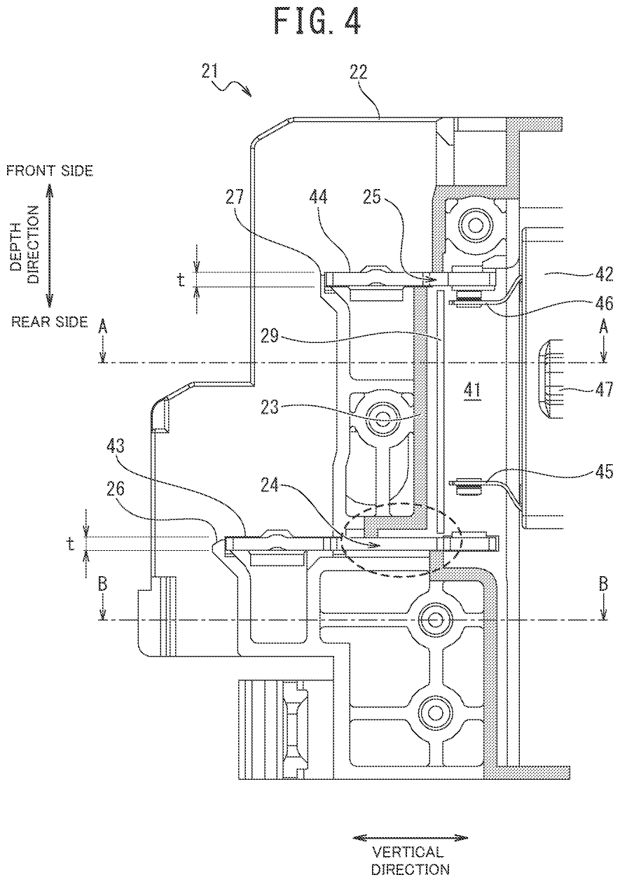

FIG. 4 is a diagram illustrative of the auxiliary contact unit 12 to which the fixed contact pieces are assembled.

In FIG. 4, illustration of the case 31 is omitted, and the case 21 viewed from the inner side in the width direction is illustrated. In addition, the tip end surface of the partition wall portion 23 is illustrated by shading.

The fixed contact piece 43 passes through the partition wall portion 23 and has the inner side in the vertical direction arranged inside the contact housing portion 41 and the outer side in the vertical direction arranged outside the contact housing portion 41. Plate thickness t of the fixed contact piece 43 is equivalent to a dimension in the depth direction of the gap 24. Therefore, when the fixed contact piece 43 is fitted into the gap 24, cut edges of the partition wall portion 23 respectively come into contact with both surfaces in the depth direction of the fixed contact piece 43 and the gap is completely plugged. Note that, when the case 31 is fitted, the fixed contact piece 43 passes through the pass-by wall portion 33 through the gap 34 thereof. A dimension in the depth direction of the gap 34 is greater than the plate thickness t of the fixed contact piece 43.

Likewise, the fixed contact piece 44 passes through the partition wall portion 23 and has the inner side in the vertical direction arranged inside the contact housing portion 41 and the outer side in the vertical direction arranged outside the contact housing portion 41. Plate thickness t of the fixed contact piece 44 is equivalent to a dimension in the depth direction of the gap 25. Therefore, when the fixed contact piece 44 is fitted into the gap 25, cut edges of the partition wall portion 23 respectively come into contact with both surfaces in the depth direction of the fixed contact piece 44 and the gap is completely plugged. Note that, when the case 31 is fitted, the fixed contact piece 44 passes through the pass-by wall portion 33 through the gap 35 thereof. A dimension in the depth direction of the gap 35 is greater than the plate thickness t of the fixed contact piece 44.

Next, the pass-by wall portions 33 will be described.

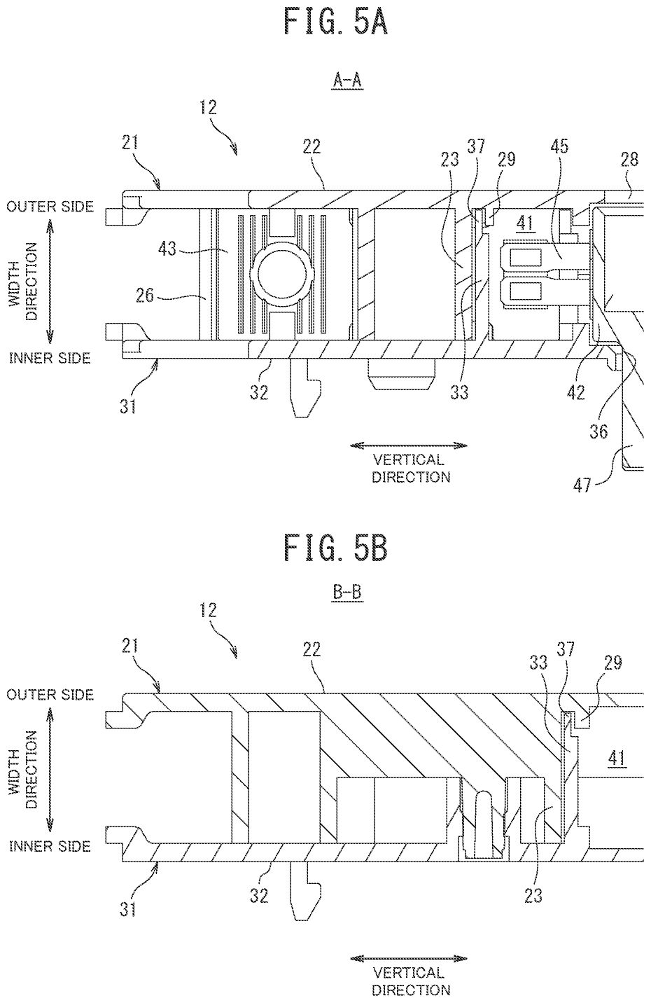

FIGS. 5A and 5B are diagrams illustrative of cross sections of the auxiliary contact unit.

FIGS. 5A and 5B illustrate a cross section taken along the line A-A in FIG. 4 and a cross section taken along the line B-B in FIG. 4, respectively. In FIGS. 5A and 5B, the auxiliary contact unit 12 to which the case 31 is assembled is illustrated, and the structures of the pass-by wall portions 33 are the same in both cross sections.

The pass-by wall portion 33 is arranged inside the contact housing portion 41 in such a manner that the pass-by wall portion 33 and the partition wall portion 23 pass by each other. Thickness of the pass-by wall portion 33 is less than thickness of the partition wall portion 23. A step is formed on the tip end side of the pass-by wall portion 33, and a tip end portion 37 of the pass-by wall portion 33 has a thickness less than a thickness on the base edge side of the pass-by wall portion 33. On the side wall portion 22, a protruding portion 29, which protrudes from the wall surface of the side wall portion 22 along the tip end portion 37 of the pass-by wall portion 33, is formed. The tip end portion 37 of the pass-by wall portion 33 is arranged between the partition wall portion 23 and the protruding portion 29. The protruding portion 29 is continuously formed along the depth direction, as illustrated in FIG. 4.

Between the pass-by wall portion 33 and the partition wall portion 23, a minute gap is formed in consideration of error at the time of molding, and the pass-by wall portion 33 and the partition wall portion 23 are not in contact with each other. A dimension in the width direction of the pass-by wall portion 33 is less than a dimension in the width direction of the partition wall portion 23. Therefore, when the case 21 and the case 31 are fitted to each other, while the tip end of the partition wall portion 23 comes into contact with the wall surface of the side wall portion 32, the tip end of the pass-by wall portion 33 does not come into contact with the wall surface of the side wall portion 22.

Between the tip end portion 37 of the pass-by wall portion 33 and the protruding portion 29, a minute gap is formed in consideration of error at the time of molding, and the tip end portion 37 of the pass-by wall portion 33 and the protruding portion 29 are not in contact with each other. A dimension in the width direction of the protruding portion 29 is less than a dimension in the width direction of the tip end portion 37 of the pass-by wall portion 33. Therefore, when the case 21 and the case 31 are fitted to each other, the tip end of the protruding portion 29 does not come into contact with a stepped surface on the tip end portion 37 of the pass-by wall portion 33.

### Advantageous Effects

Next, main advantageous effects of the one embodiment will be described.

With regard to the auxiliary contact unit 12, there is a possibility that, when dust enters the inside of the case, in particular the contact housing portion 41, the dust causes contact failure of contacts. In the present embodiment, the auxiliary contact unit 12 includes the case 21 and the case 31, which are divided from each other in the width direction, and, on the side wall portion 22 of the case 21, the partition wall portions 23, which protrude toward the case 31, are formed. On the other hand, on the side wall portion 32 of the case 31, the pass-by wall portions 33, which protrude toward the side wall portion 22 along the partition wall portions 23, are formed. Therefore, dust is required to pass between the partition wall portions 23 and the pass-by wall portions 33 to enter the contact housing portion 41. That is, a long entry pathway into the contact housing portion 41 causes dust to be less likely to enter the contact housing portion 41, as a result of which dust-resistant performance is improved.

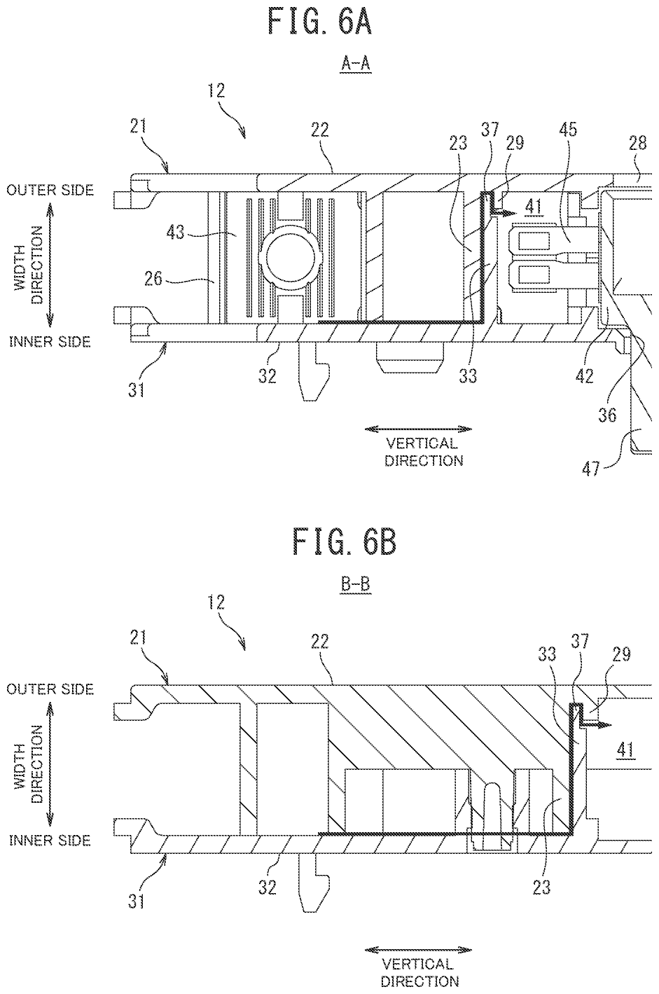

FIGS. 6A and 6B are diagrams illustrative of entry pathways for dust.

FIGS. 6A and 6B illustrate a cross section taken along the line A-A in FIG. 4 and a cross section taken along the line B-B in FIG. 4, respectively. FIGS. 6A and 6B illustrate the auxiliary contact unit 12 to which the case 31 is assembled, and structures of the pass-by wall portions 33 are the same in both cross sections.

An entry pathway for dust is indicated by a thick solid line arrow. Dust passes between the tip end of the partition wall portion 23 and the wall surface of the side wall portion 32, passes between the partition wall portion 23 and the pass-by wall portion 33, and passes between the tip end of the tip end portion 37 of the pass-by wall portion 33 and the wall surface of the side wall portion 22. Further, dust passes between the tip end portion 37 of the pass-by wall portion 33 and the protruding portion 29, passes between the tip end of the protruding portion 29 and the stepped surface of the tip end portion 37 of the pass-by wall portion 33, and finally enters the contact housing portion 41. As described above, a long entry pathway into the contact housing portion 41 causes dust to be less likely to enter the contact housing portion 41, as a result of which dust-resistant performance is improved.

In addition, the fixed contact pieces 43 and the fixed contact pieces 44 respectively pass through both the partition wall portions 23 and the pass-by wall portions 33, and, at least in the partition wall portions 23, the gaps 24 having a width equivalent to the plate thickness t of the fixed contact pieces 43 and the gaps 25 having a width equivalent to the plate thickness t of the fixed contact pieces 44 are formed. Into the gaps 24 and the gaps 25, the fixed contact pieces 43 and the fixed contact pieces 44 are fitted from the case 31 side, respectively. On this occasion, cut edges of the partition wall portions 23 respectively come into contact with both surfaces in the depth direction of the fixed contact pieces 43 and the gaps 24 are completely plugged, and cut edges of the partition wall portions 23 respectively come into contact with both surfaces in the depth direction of the fixed contact pieces 44 and the gaps 25 are completely plugged. Therefore, dust becomes less likely to enter the contact housing portion 41, as a result of which dust-resistant performance is improved.

In addition, the pass-by wall portions 33 are arranged inside the contact housing portion 41, and, on the side wall portion 22, the protruding portions 29, which protrude along the tip end portions 37 of the pass-by wall portions 33, are formed. That is, the tip end portions 37 of the pass-by wall portions 33 are arranged between the partition wall portions 23 and the protruding portions 29. Although there is a possibility that warp and bending occur on the pass-by wall portions 33, it is possible to prevent the pass-by wall portions 33 from leaning and falling down to the side on which the movable contact 45 and the movable contact 46 are located due to warp and bending, because the protruding portions 29 are arranged close to the tip end portions 37 of the pass-by wall portions 33. Therefore, there is no possibility that a problem is posed to separation and contact between the contacts associated with advancement and retraction of the contact support 42.

In addition, the tip end portion 37 of each of the pass-by wall portions 33 has a thickness less than a thickness on the base edge side of the pass-by wall portion 33. Therefore, the protruding portions 29 can be arranged closer to the side on which the partition wall portions 23 are located by a distance equivalent to the amount of reduction in the thickness of the tip end portions 37. This configuration can prevent the protruding portions 29 from narrowing a space in the contact housing portion 41.

In addition, the pass-by wall portions 33 are formed with a thickness less than the thickness of the partition wall portions 23. This configuration can prevent the pass-by wall portions 33 from narrowing the space in the contact housing portion 41.

In addition, the dimension in the width direction (protruding direction) of the pass-by wall portions 33 is set less than the dimension in the width direction (protruding direction) of the partition wall portions 23. Therefore, when the case 21 and the case 31 are fitted to each other, while the tip ends of the partition wall portions 23 come into contact with the wall surface of the side wall portion 32, there is no possibility that the tip ends of the pass-by wall portions 33 come into contact with the wall surface of the side wall portion 22. The reason for the above-described configuration is to, when the case 21 and the case 31 are fastened to each other by screws, prevent a crack or a fracture from occurring on the pass-by wall portions 33 due to the pass-by wall portions 33 having a less thickness than the partition wall portions 23 and thus having a low load bearing capacity in the width direction. That is, only the partition wall portions 23 are subjected to a force in the width direction that, when the case 21 and the case 31 are fastened to each other by screws, sticks the case 21 and the case 31 to each other. This configuration can prevent a crack or a fracture from occurring on the pass-by wall portions 33 when the case 21 and the case 31 are fastened to each other by screws.

Next, comparative examples will be described.

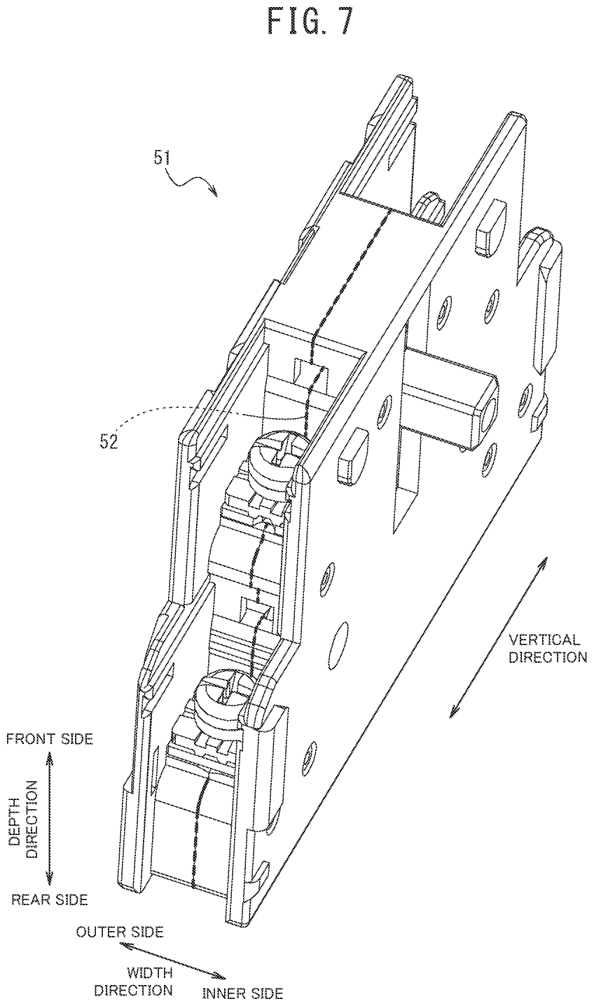

FIG. 7 is a diagram illustrative of Comparative Example 1.

An auxiliary contact unit 51 of Comparative Example 1 has a structure in which the auxiliary contact unit 51 is divided at the center in the width direction, and a division surface 52 of the division is illustrated by a thick dotted line. In the structure in which the auxiliary contact unit 51 is divided at the center in the width direction as described above, there has been a possibility that dust enters the inside of the auxiliary contact unit 51 through the division surface 52 and the dust causes contact failure of contacts. In contrast, in the present embodiment, the pass-by wall portions 33 formed as described afore cause dust to be less likely to enter the contact housing portion 41, as a result of which dust-resistant performance is improved.

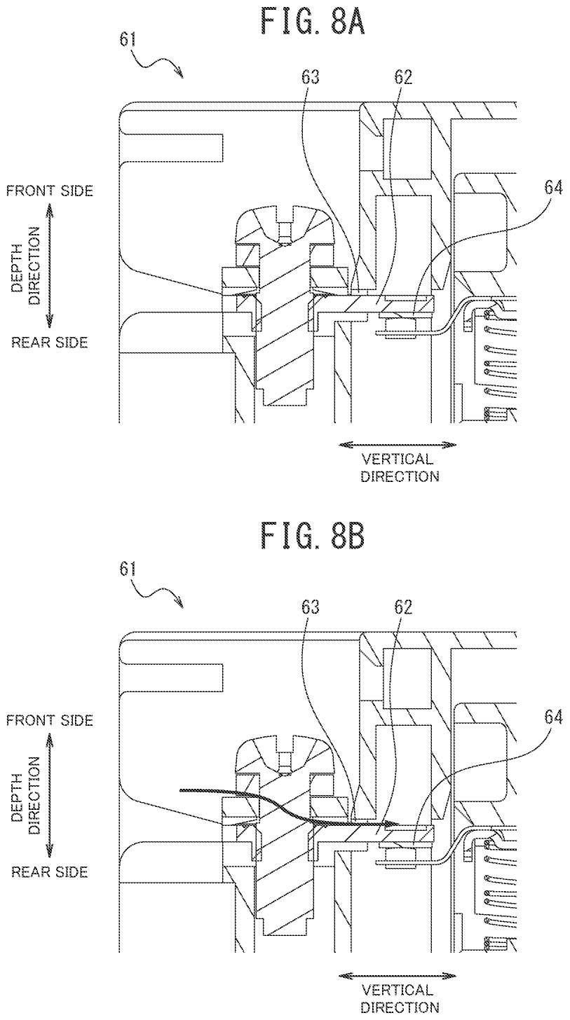

FIGS. 8A and 8B are diagrams illustrative of Comparative Example 2.

An auxiliary contact unit 61 of Comparative Example 2 has a structure of an integrally molded type, in which the auxiliary contact unit 61 is not divided in the width direction. In this case, while an insertion hole 63 for inserting a fixed contact piece 62 along the vertical direction is formed, a height dimension of the insertion hole 63 is set greater than a thickness of the fixed contact piece 62 in order to allow a fixed contact 64 formed on the fixed contact piece 62 to pass through the insertion hole 63. Hence, a gap is formed between the insertion hole 63 and the fixed contact piece 62 even in the structure of the integrally molded type, and there has been a possibility that dust enters the inside of the auxiliary contact unit 61 through the gap and the dust causes contact failure of contacts. In contrast, in the present embodiment, as described afore, the fixed contact pieces 43 and the fixed contact pieces 44 can be fitted from the case 31 side and cut edges of the partition wall portions 23 respectively come into contact with both surfaces in the depth direction of the fixed contact pieces 43 and the fixed contact pieces 44 and the gaps are completely plugged. Therefore, dust becomes less likely to enter, as a result of which dust-resistant performance is improved.

(Variations)

Although, in the one embodiment, the partition wall portions 23 are formed on the side wall portion 22 of the case 21 and the pass-by wall portions 33 are formed on the side wall portion 32 of the case 31, the present invention is not limited thereto. Conversely, the pass-by wall portions 33 may be formed on the side wall portion 22 of the case 21 and the partition wall portions 23 may be formed on the side wall portion 32 of the case 31.

Although, in the one embodiment, the main pass-by wall portions 33 are formed for the area of the partition wall portion 23 that are formed along the width direction and the depth direction on both sides in the vertical direction, the present invention is not limited thereto. That is, pass-by wall portions may be formed with respect to the whole partition wall portion 23, in other words, pass-by wall portions may also be formed for an area of the partition wall portion 23 that are formed along the width direction and the vertical direction on both sides in the depth direction.

Although, in the one embodiment, between the pass-by wall portions 33 and the partition wall portions 23, minute gaps are formed in consideration of error at the time of molding, the present invention is not limited thereto, and the pass-by wall portions 33 and the partition wall portions 23 may be configured to come into surface contact with each other. Because of this configuration, dust becomes further less likely to enter the contact housing portion 41, as a result of which dust-resistant performance is improved.

Although, in the one embodiment, the protruding portions 29 are continuously formed along the depth direction, the present invention is not limited thereto. That is, the protruding portions 29 may be formed in such a manner as to be scattered at a predetermined interval along the depth direction.

Although, in the one embodiment, the dimension in the depth direction of the gaps 34 is set greater than the plate thickness t of the fixed contact pieces 43, the present invention is not limited thereto. That is, the dimension in the depth direction of the gaps 34 may be set equal to the plate thickness t of the fixed contact pieces 43. The same applies to the gaps 35 and the fixed contact pieces 44. Because of this configuration, dust becomes further less likely to enter the contact housing portion 41, as a result of which dust-resistant performance is improved.

Although, in the one embodiment, the partition wall portions 23, which are separated by the gaps 24, form steps each of which is composed of wall portions that are displaced from each other in the vertical direction, the present invention is not limited thereto. That is, the partition wall portions 23, which are separated by the gaps 24, do not have to be displaced from each other in the vertical direction. The same applies to the partition wall portions 23 that are separated by the gaps 25.

Although the present invention has been described above with reference to a limited number of embodiments, the scope of right is not limited thereto, and it is self-evident for a person skilled in the art to apply various modifications to the embodiments based on the above-described disclosure.

### REFERENCE SIGNS LIST

11 Electromagnetic contactor
12 Auxiliary contact unit
21 Case
22 Side wall portion
23 Partition wall portion
24 Gap
25 Gap
26 Receiving wall portion
27 Receiving wall portion
28 Opening portion
29 Protruding portion
31 Case
32 Side wall portion
33 Pass-by wall portion
34 Gap
35 Gap
36 Opening portion
37 Tip end portion
41 Contact housing portion
42 Contact support
43 Fixed contact piece
44 Fixed contact piece
45 Movable contact piece
46 Movable contact piece
47 Coupling protrusion
51 Auxiliary contact unit
52 Division surface
61 Auxiliary contact unit
62 Fixed contact piece
63 Insertion hole
64 Fixed contact

1. An auxiliary contact unit to be attached on a side surface of an electromagnetic contactor, comprising
a first case and a second case, the first case and the second case being divided from each other in a direction orthogonal to a side surface of the electromagnetic contactor,
wherein the first case includes:
a first side wall portion parallel with a side surface of the electromagnetic contactor; and
a partition wall portions protruding from a wall surface of the first side wall portion toward the second case,
the second case includes
a second side wall portion parallel with a side surface of the electromagnetic contactor and having a wall surface with which, when the first case and the second case are fitted to each other, a tip end of the partition wall portion comes into contact,
a space surrounded by the first side wall portion, the partition wall portion, and the second side wall portion serves as a contact housing portion, and
the second side wall portion includes
a pass-by wall portion protruding from a wall surface toward the first side wall portion along the partition wall portion,
the pass-by wall portion is arranged inside the contact housing portion,
the first side wall portion includes
a protruding portion protruding from a wall surface along a tip end portion of the pass-by wall portion, and
a tip end portion of the pass-by wall portion is arranged between the partition wall portion and the protruding portion.

2. The auxiliary contact unit according to claim 1 comprising
a plate-shaped fixed contact piece passing through both the partition wall portion and the pass-by wall portion and having a one end side arranged inside the contact housing portion and the other end side arranged outside the contact housing portion,
wherein a gap having a distance equivalent to a plate thickness of the fixed contact piece is formed in the partition wall portion, and the fixed contact piece is fitted into the gap from the second case side.

3. The auxiliary contact unit according to claim 1, wherein a tip end portion of the pass-by wall portion has a thickness less than a thickness of a base edge side of the pass-by wall portion.

4. The auxiliary contact unit according to claims 1 to 3, wherein the pass-by wall portion has a thickness less than a thickness of the partition wall portion.

5. The auxiliary contact unit according to claim 4, wherein a dimension in a protruding direction of the pass-by wall portion is less than a dimension in a protruding direction of the partition wall portion.

6. An auxiliary contact unit to be attached on a side surface of an electromagnetic contactor, comprising
a first case and a second case, the first case and the second case being divided from each other in a direction orthogonal to a side surface of the electromagnetic contactor,
wherein the first case includes:
a first side wall portion parallel with a side surface of the electromagnetic contactor; and
a partition wall portions protruding from a wall surface of the first side wall portion toward the second case,
the second case includes
a second side wall portion parallel with a side surface of the electromagnetic contactor and having a wall surface with which, when the first case and the second case are fastened to each other by a fitting screw, a tip end of the partition wall portion comes into contact,
a space surrounded by the first side wall portion, the partition wall portion, and the second side wall portion serves as a contact housing portion, and
the second side wall portion includes
a pass-by wall portion protruding from a wall surface toward the first side wall portion along the partition wall portion,
the pass-by wall portion has a thickness less than a thickness of the partition wall portion,
a dimension in a protruding direction of the pass-by wall portion is less than a dimension in a protruding direction of the partition wall portion.

8. The auxiliary contact unit according to claim 2, wherein a tip end portion of the pass-by wall portion has a thickness less than a thickness of a base edge side of the pass-by wall portion.

9. The auxiliary contact unit according to claim 2, wherein the pass-by wall portion has a thickness less than a thickness of the partition wall portion.

10. The auxiliary contact unit according to claim 3, wherein the pass-by wall portion has a thickness less than a thickness of the partition wall portion.

11. The auxiliary contact unit according to claim 8, wherein the pass-by wall portion has a thickness less than a thickness of the partition wall portion.

12. The auxiliary contact unit according to claim 9, wherein a dimension in a protruding direction of the pass-by wall portion is less than a dimension in a protruding direction of the partition wall portion.

13. The auxiliary contact unit according to claim 10, wherein a dimension in a protruding direction of the pass-by wall portion is less than a dimension in a protruding direction of the partition wall portion.

14. The auxiliary contact unit according to claim 11, wherein a dimension in a protruding direction of the pass-by wall portion is less than a dimension in a protruding direction of the partition wall portion.
